(19) United States
(12) Patent Application Publication
(10) Pub. No.: US 2012/0234451 A1
(43) Pub. Date: Sep. 20, 2012

(54) PNEUMATIC TIRE

(75) Inventor: Akinori Miyake, Osaka (JP)

(73) Assignee: TOYO TIRE & RUBBER CO., LTD., Osaka (JP)

(21) Appl. No.: 13/404,341

(22) Filed: Feb. 24, 2012

(30) Foreign Application Priority Data
Mar. 18, 2011 (JP) 2011-061196

(51) Int. Cl. B60C 9/28

(52) U.S. Cl. 152/537; 152/538

(57) ABSTRACT

A reinforcing belt 10 in a belt layer which goes around in a circumferential direction of a pneumatic tire according to the present invention comprises plural steel cords arranged in parallel over overall length thereof, covered with a rubber, the steel cord of the reinforcing belt is arranged such that an angle θ1 between the steel cord and a tire circumferential direction satisfies 0.9πR≦W/tan θ≦1.1πR when a reinforcing belt width is W and a reinforcing belt diameter is R, the reinforcing belt in its developed state shows a parallelogram comprising circumferential direction sides 11 and 12 having the same length, parallel to a tire circumferential direction, and inclined sides 13 and 14 connecting edges of the circumferential direction sides, and the steel cord is arranged in parallel to the inclined sides.

### BACKGROUND OF THE INVENTION

1. Field of the Invention

The present invention relates to a pneumatic tire (hereinafter simply referred to as a “tire”), particularly a pneumatic tire suitable for heavy load.

2. Background Art

A radial tire for heavy load holds its shape by a binding force of a belt layer. However, in a tire having low aspect ratio, which is increasing recently, binding force is short in the conventional belt structure, and growth of an outer diameter in a tread shoulder part becomes large by running. The local growth of outer diameter gave rise to the problems of uneven wear in a shoulder part and delamination of belt edge.

In view of the above, a structure which increases binding force by arranging a belt reinforcing layer of small angle at the outside in a radial direction of a main action belt layer is proposed as shown in JP-A-03-200403 (1991). Furthermore, a structure in which a steel cord is arranged in a zigzag state between a marginal part of a belt layer and other marginal part thereof is proposed as shown in JP-A-08-183110 (1996).

However, in the structure shown in JP-A-03-200403 (1991), a certain extent of effect is obtained, but binding force still is short to a tire having low aspect ratio. Furthermore, the structure shown in JP-A-08-183110 (1996) aims at that a cut surface of a steel cord is not exposed at a belt edge. In the case that the number of zigzag is extremely reduced to decrease an angle of a belt, tension which receives load may be too larger than tensile strength of the steel cord, and there is a problem that breakage of a steel cord occurs.

### SUMMARY OF THE INVENTION

As a result of various investigations in view of the above, the present inventors have developed a tire having improved durability and uneven wear resistance performance and free of occurrence of breakage of a steel cord while holding its shape, by a binding force of a belt layer.

The tire according to the present invention improves durability of a tire by spirally winding and arranging a steel cord of a reinforcing belt layer so as to nearly go around a tire from a marginal part of a belt layer to other marginal part thereof.

Specific constitution of the tire according to the present invention comprises a reinforcing belt arranged in a belt layer which goes around in a tire tread part in a tire circumferential direction, wherein the reinforcing belt comprises plural steel cords arranged in parallel over overall length thereof, covered with a rubber, the steel cord of the reinforcing belt is arranged such that an angle θ between the steel cord and a tire circumferential direction satisfies a range of 0.9πR≦W/tan θ≦1.1πR when a reinforcing belt width is W and a reinforcing belt diameter is R, the reinforcing belt in its developed state shows a parallelogram comprising circumferential direction sides having the same length, parallel to a tire circumferential direction, and inclined sides connecting edges of the circumferential direction sides, a length of the circumferential direction side is a circumferential length πR of the reinforcing belt, a length of the inclined side is a length of the steel cord, a distance of two circumferential direction sides is a reinforcing belt width W, and the steel cord is arranged in parallel to the inclined sides. Where the W/tan θ is smaller than 0.9πR, a hoop effect of the belt is difficult to be obtained. Where W/tan θ is larger than 1.1πR, a circumferential direction component of a steel cord angle becomes large, and breakage of the steel cord may occur by strain.

In the above constitution, two main working belts comprising a steel cord covered with a rubber are arranged up and down in the belt layer which goes around in a tire tread, and the reinforcing belt maybe arranged between the upper and lower two main working belts.

The tire may have a constitution that a diameter of the steel cord of the reinforcing belt is smaller than a diameter of the steel cord of the main working belt. In the case of such a constitution, a thickness of a tire can be decreased, resulting in low generation of heat. As a result, durability is improved.

Furthermore, the tire may have a constitution that a cut angle of the edge of the steel cord of the reinforcing belt is larger than an angle between the steel cord and a tire circumferential direction. The cut angle of the edge of the steel cord of the reinforcing belt is preferably from 20° to 90°. In the case that the cut angle of the edge of the steel cord of the reinforcing belt is 20° or more, a distance between the steel cord edges becomes large. As a result, separations between the steel cord and a rubber occurred at the edge of each steel cord are difficult to connect to each other.

The reinforcing belt may have a constitution that its width is wider than 65% of the overall width of a tire and is narrower than larger width of two main working belts. Where the width of the reinforcing layer is equal to or less than 65% of the overall width of a tire, growth of an outer diameter in a tread shoulder part is not suppressed. On the other hand, where the width of the reinforcing layer is wider than the larger width of the main working belts, the belt edge is located in a region of large deformation during loading. As a result, trouble is easy to occur.

The tire may have a constitution that an aspect ratio of a tire having the reinforcing belt arranged therein is 60% or less.

When the tire according to the present invention has the above constitution, each steel cord in the reinforcing belt has a spiral state nearly going around a tire, and the growth of an outer diameter is effectively suppressed. Furthermore, at the belt edge and in the belt, the rubber between the steel cords appropriately relaxes strain of the steel cord occurred by load applied to a tire. As a result, breakage of the steel cord can be prevented without using a special steel cord. Eventually, occurrence of delamination at the belt edge can be prevented, and a tire having excellent durability is obtained.

### BRIEF DESCRIPTION OF THE DRAWINGS

FIGS. 1A and 1B are schematic views of the reinforcing belt according to a first embodiment of the present invention. FIG. 1A shows a wound state, and FIG. 1B shows a developed state.

FIG. 2 is a partially omitted sectional view of the tire according to the first embodiment of the present invention.

FIG. 3 is an explanatory view showing a cut state of the edge of a steel cord in the reinforcing belt according to the first embodiment of the present invention.

FIGS. 4A and 4B are schematic views of the reinforcing belt according to a second embodiment of the present invention. FIG. 4A shows a wound state, and FIG. 4B shows a developed state.

FIGS. 5A and 5B are schematic views of the reinforcing belt according to a third embodiment of the present invention. FIG. 5A shows a wound state, and FIG. 5B shows a developed state.

FIGS. 6A and 6B are explanatory views showing an arrangement relationship between a main working belt and a reinforcing belt in Comparative Test 1. FIG. 6A is Conventional Example, and FIG. 6B is Example and Comparative Example.

### DETAILED DESCRIPTION OF THE INVENTION

The preferred embodiment of the tire according to the present invention is described in detail below by reference to the accompanying drawings.

### First Embodiment

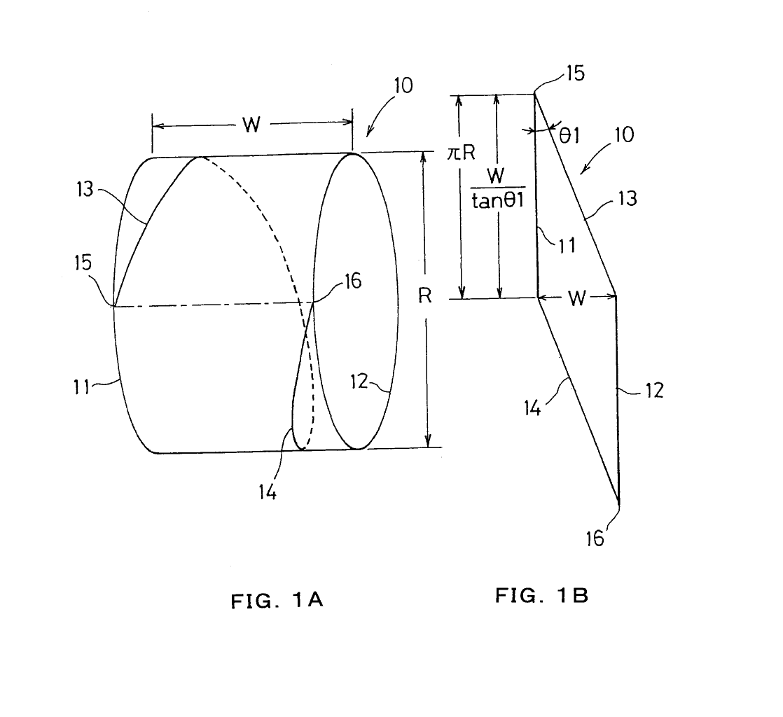

FIG. 1A shows a state that a parallelogram reinforcing belt 10 shown in FIG. 1B is cylindrically wound. In FIGS. 1A and 1B, W shows a width of a reinforcing belt, R shows a diameter of a reinforcing belt, 10 shows a reinforcing belt, 11 and 12 show circumferential direction sides of the reinforcing belt 10, 13 and 14 show inclined sides of the reinforcing belt 10, 15 shows an upper edge in a developed state of the reinforcing belt 10, 16 shows a lower edge in a developed state of the reinforcing belt 10, and θ1 shows an angle between the circumferential direction sides 11 and 12 and the inclined sides 13 and 14, respectively. As shown in FIG. 2, the reinforcing belt 10 is incorporated in a tread part B of a tire A, and forms a part of a belt layer C of the tread part B. In FIG. 2, A shows a tire, B shows a tread part, C shows a belt layer, C1 shows a main working belt of a lower layer, C2 shows a main working belt of an upper layer, C3 shows a protective belt, D shows a carcass, and 10 shows a reinforcing belt. The belt layer C is laminated on the upper part of the carcass D, and has a four layer structure comprising the main working belt C1, the reinforcing belt 10 according to the first embodiment, the main working belt C2 and the protective belt C3, in the order from the lower layer, and each is arranged so as to go around the inside of the tread part. The main working belt C1, the reinforcing belt 10 according to the first embodiment, the main working belt C2 and the protective belt C3 each are formed by a belt material comprising a steel cord covered with a rubber. Because a diameter of the steel cord in the reinforcing belt 10 is smaller than a diameter of the main working belts C1 and C2, a thickness of the tire A can be decreased, making generation of heat low, and as a result, durability is improved. In the first embodiment, the overall width of the tire A is 445 mm, the width W of the reinforcing belt 10 is 320 mm, the width of the main working belt C1 is 370 mm, and the width of the main working belt C2 is 340 mm. Thus, because the tire A has the constitution that the width W of the reinforcing belt 10 is wider than about 290 mm which is 65% of the overall width of the tire A and is narrower than the main working belt C1 which has larger width in two main working belts, the growth of an outer diameter in the tread shoulder part can be suppressed. Because the belt edge is not located in a region having large deformation during loading, there is the advantage that trouble is difficult to occur. Furthermore, the tire A in the first embodiment can achieve the effect of the first embodiment even though the aspect ratio of the tire is 60% or less.

As shown in FIG. 1B, the reinforcing belt 10 shows, in its developed state, a parallelogram comprising two circumferential direction sides 11 and 12 having the same length, parallel to a tire circumferential direction, and two parallel inclined sides 13 and 14 connecting edges of the circumferential direction sides, and as shown in FIG. 1A, when a diameter is R and a width is W when the reinforcing belt 10 is cylindrically wound, the length of the circumferential direction sides 11 and 12 is a circumferential length πR of the reinforcing belt, and a distance between the circumferential direction sides 11 and 12 is the width W of the reinforcing belt.

In the first embodiment, when the parallelogram reinforcing belt 10 shown in FIG. 1B is cylindrically wound, the reinforcing belt 10 is formed such that the length between the upper edge 15 and the lower edge 16 just goes around as shown in FIG. 1A. To form the reinforcing belt 10 like this, the parallelogram shown in FIG. 1B is a parallelogram comprising the circumferential direction side 11 having a length πR which is a circumferential length and the circumferential direction side 12 which is displaced lower with the length of the circumferential direction side 11 at an interval of the width W. Indicating this by a numerical expression, when an angle between the circumferential direction side 11 and the inclined side 13 is θ1, the parallelogram formed by the circumferential direction side 11 having the length πR and the width W is a parallelogram satisfying πR=W/tan θ1. The θ1 in this case is about 6.1° when the width W of the reinforcing belt is 320 mm and the diameter R of the reinforcing belt is 960 mm as in the first embodiment.

The steel cords are provided in parallel to the inclined sides 13 and 14 in FIG. 1B, in the reinforcing belt 10. Therefore, edge cut parts of all of the steel cords are located in the circumferential direction sides 11 and 12, and all of the steel cords are cylindrically wound in the tire tread B without discontinuation. Thus, the tire A according to the first embodiment improves durability of the tire A by spirally winding and arranging the steel cords of the reinforcing belt 10 from the circumferential direction side 11 which is the marginal part of the reinforcing belt 10 to the circumferential direction side 12 which is other marginal part so as to go around the tire.

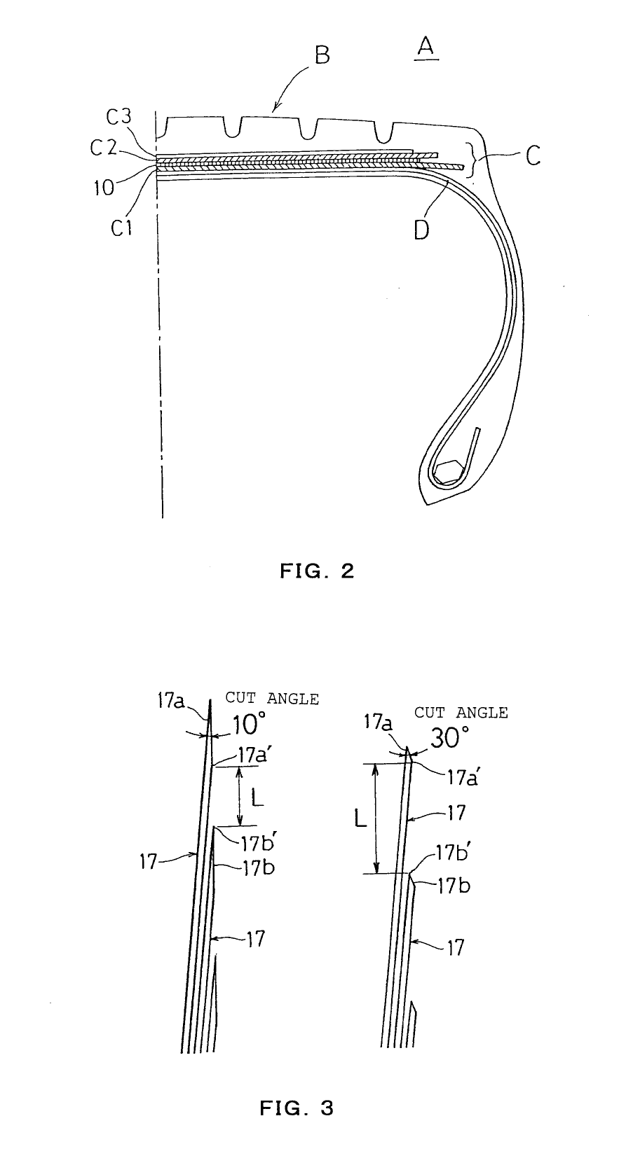

The reinforcing belt 10 is cut at 10° of the cut angle of the edge of the steel cord, which is larger than 6.1° which is the angle θ1 between the steel cord and the tire circumferential direction. Thus, when the reinforcing belt 10 is cut at an angle between the steel cord and the tire circumferential direction of θ1 or more, a distance L between a lower part 17a′ of a cord edge 17a of a steel cord 17 and an upper part 17b′ of a cord edge 17b of the steel cord 17 becomes large as shown in FIG. 3. As a result, there is an advantage that separations of a rubber occurred in the cord edges 17a and 17b are difficult to connect. In FIG. 3, 17 indicates a steel cord, 17a indicates a cord edge of a steel cord, 17a′ indicates a lower part of a cord edge of a steel cord, 17b indicates a cord edge of a steel cord, 17b′ indicates an upper part of a cord edge of a steel cord, and L indicates a distance between the lower part 17a′ of the cord edge 17a of the steel cord 17 and the upper part 17b′ of the cord edge 17b of the steel cord 17. FIG. 3 shows the case of the cut angle 10° and the case of the cut angle 30°. Each case is that the distance L between the lower part 17a′ of the cord edge 17a and the upper part 17b′ of the cord edge 17b is large, and it is apparent that distance L between the lower part 17a′ of the cord edge 17a and the upper part 17b′ of the cord edge 17b becomes large in the case of the cut angle 30° rather than the case of the cut angle 10°, that is, with increasing the cut angle. On the other hand, where the cut angle of the edge of the steel cord is smaller than the angle θ1 between the steel cord and the tire circumferential direction, the edge lower part 17a′ of the upper steel cord 17 comes close to the edge upper part 17b′ of the lower steel cord 17, so that opening edges of a rubber, formed by covering the steel cord with the rubber come close to each other. As a result, separations between a steel cord and a rubber occurred at the edge of each steel cord are connected to each other, and the rubber may separate at the steel cord as a boundary. Considering the change of angle between the steel cord and the tire circumferential direction, the cut angle is preferably from 20° to 90° in that the steel cord is prevented from being separated, thereby stabilized durability of a tire is achieved.

### Second Embodiment

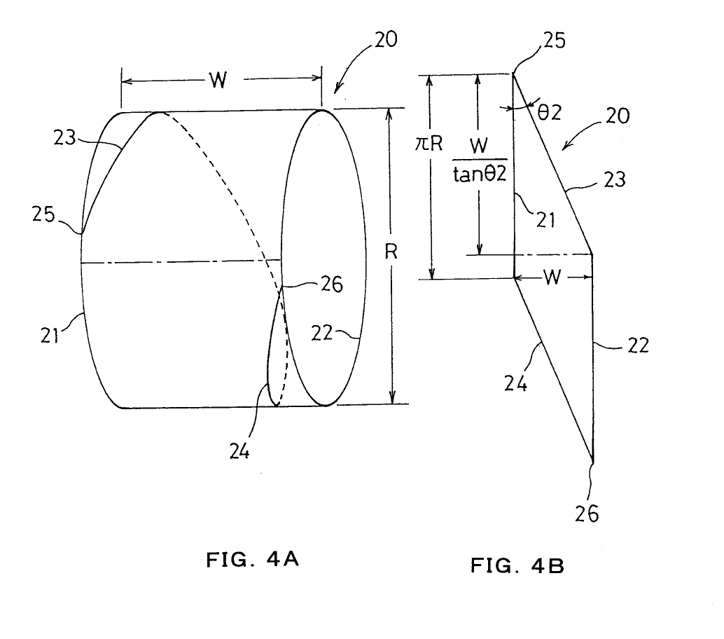

FIG. 4A shows a state that the parallelogram reinforcing belt 20 shown in FIG. 4B is cylindrically wound. In FIGS. 4A and 4B, W indicates a width of a reinforcing belt, R indicates a diameter of a reinforcing belt, 20 indicates a reinforcing belt, 21 and 22 indicate circumferential direction sides of the reinforcing belt 20, 23 and 24 indicate inclined sides of the reinforcing belt 20, 25 indicates an upper edge in a developed state of the reinforcing belt 20, 26 indicates a lower edge in a developed state of the reinforcing belt 20, and θ2 indicates an angle between the circumferential direction sides 21 and 22 and the inclined sides 23 and 24, respectively. The reinforcing belt 20 has basically the same cross-sectional structure and circumferential structure as the tire A shown in FIG. 2 in the first embodiment.

As shown in FIG. 4B, the reinforcing belt 20 shows, in its developed state, a parallelogram comprising two circumferential direction sides 21 and 22 having the same length, parallel to a tire circumferential direction, and two inclined sides 23 and 24 connecting edges of the circumferential direction sides, and as shown in FIG. 4A, when a diameter is R and a width is W when the reinforcing belt 20 is cylindrically wound, the length of the circumferential direction sides 21 and 22 is a circumferential length πR of the reinforcing belt, and a distance between the circumferential direction sides 21 and 22 is the width W of the reinforcing belt.

In the second embodiment, when the parallelogram reinforcing belt 20 shown in FIG. 4B is cylindrically wound, the reinforcing belt 20 is formed such that the length between the upper edge 5 and the lower edge 26 is slightly shorter than one round as shown in FIG. 4A. To form the reinforcing belt like this, the parallelogram shown in FIG. 4B is a parallelogram comprising the circumferential direction side 21 having a length πR which is a circumferential length and the circumferential direction side 22 which is displaced lower with the length slightly shorter than the length of the circumferential direction side 21 at an interval of the width W. Indicating this by a numerical expression, when an angle between the circumferential direction side 21 and the inclined side 23 is θ2, the parallelogram formed by the circumferential direction side 21 having the length πR and the width W is a parallelogram satisfying W/tan θ2<πR. The θ2 in the case of W/tan θ2=0.9πR is about 6.7° when the width W of the reinforcing belt is 320 mm and the diameter R of the reinforcing belt is 960 mm as in the second embodiment.

The steel cords are provided in parallel to the inclined sides 23 and 24 in FIG. 4B, in the reinforcing belt 20. Therefore, edge cut parts of all of the steel cords are located in the circumferential direction sides 21 and 22, and all of the steel cords are cylindrically wound in the tire tread without discontinuation. Thus, the tire according to the second embodiment improves its durability by spirally winding and arranging the steel cords of the reinforcing belt 20 from the circumferential direction side 21 which is the marginal part of the reinforcing belt 20 to the circumferential direction side 22 which is other marginal part so as to nearly go around the tire.

### Third Embodiment

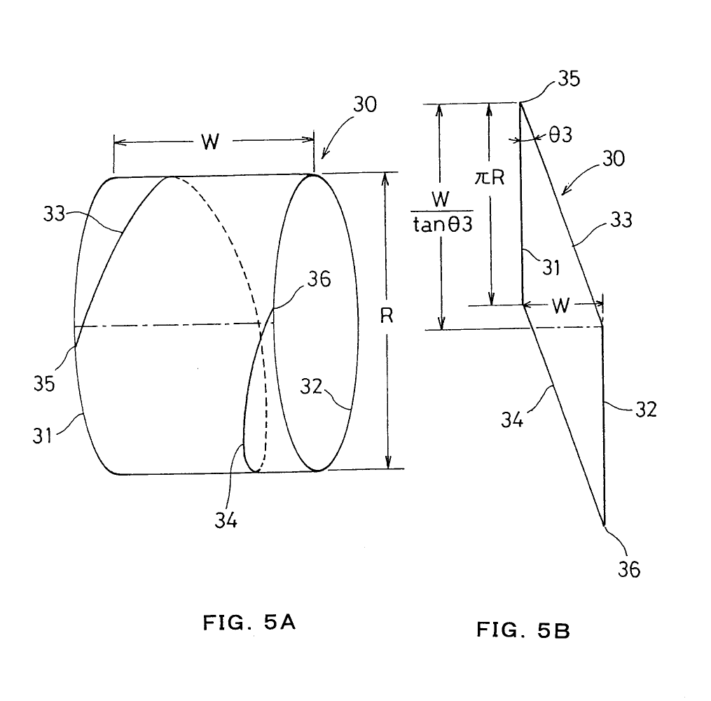

FIG. 5A shows a state that the parallelogram reinforcing belt 30 shown in FIG. 5B is cylindrically wound. In FIGS. 5A and 5B, W indicates a width of a reinforcing belt, R indicates a diameter of a reinforcing belt, 30 indicates a reinforcing belt, 31 and 32 indicate circumferential direction sides of the reinforcing belt 30, 33 and 34 indicate inclined sides of the reinforcing belt 30, 35 indicates an upper edge in a developed state of the reinforcing belt 30, 36 indicates a lower edge in a developed state of the reinforcing belt 30, and θ3 indicates an angle between the circumferential direction sides 31 and 32 and the inclined sides 33 and 34, respectively. The reinforcing belt 30 has basically the same cross-sectional structure and circumferential structure as the tire A shown in FIG. 2 in the first embodiment.

As shown in FIG. 5B, the reinforcing belt 30 shows, in its developed state, a parallelogram comprising two circumferential direction sides 31 and 32 having the same length, parallel to a tire circumferential direction, and two parallel inclined sides 33 and 34 connecting edges of the circumferential direction sides, and as shown in FIG. 5A, when a diameter is R and a width is W when the reinforcing belt 30 is cylindrically wound, the length of the circumferential direction sides 31 and 32 is a circumferential length πR of the reinforcing belt, and a distance between the circumferential direction sides 31 and 32 is the width W of the reinforcing belt.

In the third embodiment, when the parallelogram reinforcing belt 30 shown in FIG. 5B is cylindrically wound, the reinforcing belt 30 is formed such that the length of the upper edge 35 and the lower edge 36 is slightly longer than one round as shown in FIG. 5A. To form the reinforcing belt like this, the parallelogram shown in FIG. 5B is a parallelogram comprising the circumferential direction side 31 having a length πR which is a circumferential length and the circumferential direction side 32 which is displaced lower with the length slightly longer than the length of the circumferential direction side 31 at an interval of the width W. Indicating this by a numerical expression, when an angle between the circumferential direction side 31 and the inclined side 33 is θ3, the parallelogram formed by the circumferential direction side 31 having the length πR and the width W is a parallelogram satisfying πR<W/tan θ3. The θ3 in the case of W/tan θ3=1.1πR is about 5.5° when the width W of the reinforcing belt is 320 mm and the diameter R of the reinforcing belt is 960 mm as in the third embodiment.

The steel cords are provided in parallel to the inclined sides 33 and 34 in FIG. 5B, in the reinforcing belt 30. Therefore, edge cut parts of all of the steel cords are located in the circumferential direction sides 31 and 32, and all of the steel cords are cylindrically wound in the tire tread without discontinuation. Thus, the tire according to the third embodiment improves its durability by spirally winding and arranging the steel cords of the reinforcing belt 30 from the circumferential direction side 31 which is the marginal part of the reinforcing belt 30 to the circumferential direction side 32 which is other marginal part so as to nearly go around the tire.

### EXAMPLES

### Comparative Tests

The fact that the steel cords of the reinforcing belt are preferably arranged such that the angle θ between the steel cord and the tire circumferential direction satisfies a range of 0.9πR≦W/tan θ≦1.1πR when a width of a reinforcing belt is W and a diameter of a reinforcing belt is R, the fact that the reinforcing belt is preferably arranged between upper and lower two main working belts, and the fact that the reinforcing belt preferably has the constitution that its width is wider than 65% of the overall width of the tire and is narrower than the wider length of the two main working belts, as shown in the above each embodiment are clarified by the following Comparative Tests 1 and 2 in which the tire of Example (1) based on the first embodiment, the tire of Example (2) based on the second embodiment and the tire of Example (3) based on the third embodiment are prepared.

### Comparative Test 1

Using the tires according to Examples (1), (2) and (3), Comparative Tests are conducted in the following manners. That is, to confirm durability of the conventional tire, three tires of Examples (1), (2) and (3) according to the present invention, and two tires of Comparative Examples (1) and (2), a tire having a tire size of 445/50R22.5 (tire overall width 445 mm) is used as a test tire, the test tire is mounted to a wheel having a rim size of 22.5×14.00, the wheel is attached to a drum testing machine as air pressure 1,000 kPa, and running test is carried out under the conditions of a speed of 40 km/h and a load of 54.4 kN. Running distance until the tire is broken is measured. The evaluation results are shown by the index in which the conventional example is 100. The results mean that durability of a belt is excellent as the index value is large. To confirm uneven wear resistance performance of the above six tires, after running 80,000 km on a dry road surface, a width of a step wear part occurred in a shoulder rib edge is measured, and the reverse number is indicated as an index. Furthermore, steel cords of the reinforcing belt are extracted from the tire after completion of the durability test, and the presence or absence of breakage of the steel cords is confirmed.

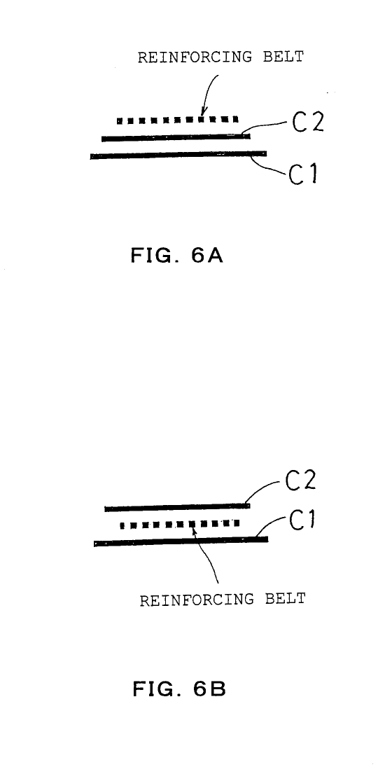

The Conventional Example is that the reinforcing belt in which W/tan θ is 0.9πR is arranged outside in a radial direction of two main working belts C1 and C2, as shown in FIG. 6A. Comparative Example (1) is that the reinforcing belt in which W/tan θ is 0.8πR which is less than 0.9πR is arranged between two main working belts C1 and C2 as shown in FIG. 6B. In FIGS. 6A and 6B, C1 indicates a main working belt of a lower layer, and C2 indicate a main working belt of an upper layer. Comparative Example (2) is that a reinforcing belt in which W/tan θ is 1.2πR which exceeds 1.1πR is arranged between two main working belts C1 and C2 as shown in FIG. 6B. Examples 1, 2 and 3 of three tires according to the present invention are that each of the tires in which W/tan θ is 0.9πR, W/tan θ is 1.0πR and W/tan θ is 1.1πR is arranged between two main working belts C1 and C2 as shown in FIG. 6B. The main working belt C1 at the lower side is that a belt width is 370 mm and a belt angle (angle of steel cord) is 17° at the right. The main working belt C2 at the upper side is that a belt width is 340 mm and a belt angle (angle of steel cord) is 17° at the left. Even though W/tan θ is 0. 9πR in the Conventional Example and Example (1), the respective belt angles in Table 1 differ. The reason for this is that because the reinforcing belt in the Conventional Example is arranged at the outside in a radial direction of the two main working belts C1 and C2, a diameter of the reinforcing belt is 965 mm which is larger than the diameter of 960 mm of the reinforcing belt of Example (1).

Measurement results of Comparative Test 1 are shown in Table 1. In Table 1, the unit of a reinforcing belt width is mm. As a result of Comparative Test, Examples (1), (2) and (3) in which W/tan θ is fallen in a range of 0.9πR≦W/tan θθ1.1πR each are that durability and uneven wear resistance performance are improved as compared with those of the Conventional Example. Comparative Example (1) in which W/tan θ is less than 0.9πR is that durability and uneven wear resistance performance are lowered as compared with those of the Conventional Example. Comparative Example (2) in which W/tan θ exceeds 1.1πR is that breakage of steel cord occurred. Therefore, good results are obtained in Examples (1), (2) and (3) by that W/tan θ is fallen in a range of 0.9πR≦W/tan θ≦1.1πR and a reinforcing belt is arranged between the main working belts C1 and C2.

TABLE 1

| | Conventional | Comparative | Example | Example | Example | Comparative |
|---|---|---|---|---|---|---|
| | Example | Example (1) | (1) | (2) | (3) | Example (2) |
| W/tan θ | 0.9πR | 0.8πR | 0.9πR | 1.0πR | 1.1πR | 1.2πR |
| Belt angle | 6.0° | 7.6° | 6.7° | 6.1° | 5.5° | 5.1° |
| Reinforcing belt width | 320 | 320 | 320 | 320 | 320 | 320 |
| Durability | 100 | 93 | 103 | 113 | 123 | 133 |
| Uneven wear | 100 | 94 | 103 | 112 | 121 | 130 |
| resistance | | | | | | |
| performance | | | | | | |
| Cord breakage | None | None | None | None | None | Occurred |

### Comparative Test 2

Comparative Test 2 is conducted in the same manner as in Comparative Test 1, except that W/tan θ in Comparative Examples (1) and (2) and Examples (1), (2) and (3) is 1.0πR and the width of the reinforcing belt is sequentially widened, and durability and uneven wear resistance performance are measured. The measurement results of Comparative Test 2 are shown in Table 2. In Table 2, the unit of the reinforcing belt width is mm. As a result of Comparative Test 2, Comparative Example (1) in which the reinforcing belt width is narrower than any of widths of the main working belts is that durability and uneven wear resistance performance are lower than those of the Conventional Example. Furthermore, Comparative Example (2) in which the reinforcing belt width is wider than any of widths of the main working belts is that durability is lower than those of the Conventional Example. Therefore, good results are obtained in Examples (1), (2) and (3) by that the reinforcing belt width is wider than 65% of the overall width of the tire and is narrower than the wider width of the main working belt C1.

TABLE 2

| | Conventional | Comparative | Example | Example | Example | Comparative |
|---|---|---|---|---|---|---|
| | Example | Example (1) | (1) | (2) | (3) | Example (2) |
| W/tan θ | 0.9πR | 1.0πR | 1.0πR | 1.0πR | 1.0πR | 1.0πR |
| Belt angle | 6.0° | 5.3° | 5.7° | 6.1° | 6.8° | 7.2° |
| Reinforcing belt width | 320 | 280 | 300 | 320 | 360 | 380 |
| Durability | 100 | 97 | 105 | 113 | 121 | 95 |
| Uneven wear | 100 | 96 | 104 | 112 | 120 | 128 |
| resistance | | | | | | |
| performance | | | | | | |

Width of main working belt C1: 370 mm
Width of main working belt C2: 340 mm

The tire according to the present invention is not limited to the above embodiments, and various embodiments are possible in a range which does not deviate from the constitution described in the claims.

What is claimed is:

1. A pneumatic tire comprising a reinforcing belt arranged in a belt layer which goes around in a tire tread part in a tire circumferential direction, wherein
the reinforcing belt comprises plural steel cords arranged in parallel over overall length thereof, covered with a rubber,
the steel cord of the reinforcing belt is arranged such that an angle θ between the steel cord and a tire circumferential direction satisfies a range of 0.9πR≦W/tan θ≦1.1πR when a reinforcing belt width is W and a reinforcing belt diameter is R,
the reinforcing belt in its developed state shows a parallelogram comprising circumferential direction sides having the same length, parallel to a tire circumferential direction, and inclined sides connecting edges of the circumferential direction sides, a length of the circumferential direction side is a circumferential length πR of the reinforcing belt, a length of the inclined side is a length of the steel cord, and a distance of two circumferential direction sides is a reinforcing belt width W, and
the steel cord is arranged in parallel to the inclined sides.

2. The pneumatic tire according to claim 1, wherein
two main working belts comprising a steel cord covered with a rubber are arranged up and down in the belt layer which goes around in a tire tread, and
the reinforcing belt is arranged between the upper and lower two main working belts.

3. The pneumatic tire according to claim 2, wherein
the steel cord of the reinforcing belt has a diameter equal to or smaller than a diameter of the steel cord of the main working belt.

4. The pneumatic tire according to claim 1, wherein
a cut angle of the edge of the steel cord of the reinforcing belt is equal to or larger than an angle between the steel cord and a tire circumferential direction.

5. The pneumatic tire according to claim 1, wherein
the cut angle of the edge of the steel cord of the reinforcing belt is preferably from 20° to 90°.

6. The pneumatic tire according to claim 2, wherein
the reinforcing belt has a width equal to or wider than 65% of the overall width of a tire and narrower than larger width of the two main working belts.

7. The pneumatic tire according to claim 1, wherein an aspect ratio of a tire having the reinforcing belt arranged therein is 60% or less.
